(19) United States
(12) Patent Application Publication
(10) Pub. No.: US 2021/0034895 A1
(43) Pub. Date: Feb. 4, 2021

(54) MATCHER BASED ANTI-SPOOF SYSTEM

(71) Applicant: QUALCOMM Incorporated, San Diego, CA (US)

(72) Inventors: Fitzgerald JOHN ARCHIBALD, Richmond Hill (CA); Jin GU, Gloucester (CA); Alexei STOIANOV, Toronto (CA); Shounak Uday GORE, Williamsville, NY (US); John SCHNEIDER, Williamsville, NY (US)

(21) Appl. No.: 16/526,658

(22) Filed: Jul. 30, 2019

(51) Int. Cl. G06K 9/00; G06F 21/32; G06K 9/62

(52) U.S. Cl. CPC G06K 9/00906; G06K 9/6232; G06F 21/32; G06K 9/00114

(57) ABSTRACT

Techniques for improving the integrity and performance of biometric security processes on data processing devices are provided. An example of a method of determining a liveness of a biometric input according to the disclosure includes obtaining inquiry image information, obtaining enrollment image information, determining alignment information based on the inquiry image information and the enrollment image information, determining an overlap area based on the alignment information, determining anti-spoofing features based on the overlap area within the inquiry image information and the enrollment image information, and outputting a liveness score based on the anti-spoofing features.

### BACKGROUND

An aspect of this invention generally relates to data processing devices and more particularly to performing biometric authentication within a data processing device. A typical authentication process relies on matching the biometric information submitted by the user with a previously established and stored template, which is a data representation of a source biometric sample. False or spoofed biometric inputs may be used to attack a trusted biometric system. A falsified biometric trait, such as a fake finger comprised of wax, clay, gummy bears, etc., may be presented to a biometric scanner in an effort to by-pass security restrictions. Authentication algorithms may include anti-spoofing techniques to help distinguish between live and spoofed biometric traits. In general, many anti-spoofing techniques are developed for large area sensors which may allow for improved accuracy in determining between live and spoofed inputs. Smaller sensors, however, may be constrained by a smaller active area and other anomalies induced by the sensor configuration (e.g., under a display area) which may make detecting spoofed inputs more difficult.

### SUMMARY

An example of a method of determining a liveness of a biometric input according to the disclosure includes obtaining inquiry image information, obtaining enrollment image information, determining alignment information based on the inquiry image information and the enrollment image information, determining an overlap area based on the alignment information, determining anti-spoofing features based on the overlap area within the inquiry image information and the enrollment image information, and outputting a liveness score based on the anti-spoofing features.

Implementations of such a method may include one or more of the following features. The inquiry image information and the enrollment image information may be time-based signals. Obtaining the inquiry image information may include obtaining feature vectors derived from an inquiry image. Obtaining the enrollment image information may include obtaining a user identification and retrieving an enrollment template from an enrollment database based on the user identification. A matching score based on the inquiry image information and the enrollment image information by be determined. The anti-spoofing features may be obtained from features in the overlap area of both the inquiry image information and the enrollment image information, such that the overlap area is determined by a matching algorithm. The biometric input may be a fingerprint and the matching score may be based on key points and descriptors in the inquiry image information and the enrollment image information. The anti-spoofing features may include the alignment information. The biometric input may be a fingerprint and the anti-spoofing features include at least one of a ridge-valley contrast, a ridge-valley thickness ratio, or a ridge-continuity information within the overlap area within the inquiry image information and the enrollment image information. The biometric input may be a fingerprint and the anti-spoofing features include at least one of a noise pattern, a noise characteristic, or a deformation result. Determining the anti-spoofing features may include transforming the overlap area within the inquiry image information and the enrollment image information to a frequency domain to determine a matching score. Transforming the overlap area within the inquiry image information and the enrollment image information to the frequency domain may include determining at least one of a fingerprint frequency, a noise frequency, a frequency shift, or a rotation or scaling transformation at different frequencies. Outputting the liveness score may include outputting a matching score based on global and local deformation results. Outputting the liveness score may include outputting a matching score based on comparing fine fingerprint features in the overlap area of the inquiry image information and the enrollment image information. The fine fingerprint features may be obtained by a smart subtraction of a raw image and a corresponding reconstructed image. Outputting the liveness score may include executing local binary pattern (LBP) operations with anti-spoofing features located in the overlap area of the inquiry image information and the enrollment image information. The anti-spoofing features may be saved as a liveness template. Outputting the liveness score may be based at least in part on a comparison of the anti-spoofing features and a previously stored liveness template.

An example method for determining a liveness score for a biometric input according to the disclosure includes obtaining an inquiry signal associated with a user, obtaining at least one enrollment template associated with the user, determining alignment information based on the inquiry signal and the at least one enrollment template, obtaining at least one anti-spoofing template associated with the user, determining anti-spoofing features based on the inquiry signal and the at least one enrollment template, and outputting the liveness score based on the anti-spoofing features and the at least one anti-spoofing template.

Implementations of such a method may include one or more of the following features. The method may include determining an overlap portion based on the alignment information, and determining the anti-spoofing features based on the overlap portion within the inquiry signal and the at least one enrollment template. The overlap portion may be an overlap area extending in two dimensions. The liveness score may be based on comparing fine fingerprint features in the overlap portion of the inquiry signal and the at least one enrollment template. The fine fingerprint features may be obtained by a smart subtraction of a raw image and a corresponding reconstructed image. Determining the alignment information may include determining a matching score based on keypoints and descriptors in the inquiry signal and the at least one enrollment template. Obtaining the at least one anti-spoofing template associated with the user may include obtaining an anti-spoofing template that is associated with the at least one enrollment template. The at least one anti-spoofing template may include liveness features extracted from a prior enrollment signal. The at least one anti-spoofing template may include liveness features extracted from a prior inquiry signal. The at least one anti-spoofing template may include information associated with at least one of a body temperature sensor, a temperature gradient, a fingerprint depth map, or an amplitude scan.

An example of an apparatus for determining a liveness of a biometric input according to the disclosure includes means for obtaining inquiry image information, means for obtaining enrollment image information, means for determining alignment information based on the inquiry image information and the enrollment image information, means for determining an overlap area based on the alignment information, means for determining anti-spoofing features based on the overlap area within the inquiry image information and the enrollment image information, and means for outputting a liveness score based on the anti-spoofing features.

An example of an apparatus for determining a liveness score for a biometric input according to the disclosure includes a biometric sensor, a memory, at least one processor operably coupled to the biometric sensor and the memory, configured to obtain an inquiry signal associated with a user from the biometric sensor, obtain at least one enrollment template associated with the user, determine alignment information based on the inquiry signal and the at least one enrollment template, obtain at least one anti-spoofing template associated with the user, determine anti-spoofing features based on the inquiry signal and the at least one enrollment template, and output the liveness score based on the anti-spoofing features and the at least one anti-spoofing template.

Items and/or techniques described herein may provide one or more of the following capabilities, as well as other capabilities not mentioned. One or more biometric enrollment templates may be associated with a user. Inquiry signals may be generated by a biometric sensor and matched with one or more of the enrollment templates. An overlap portion between the inquiry signal and an enrollment template may be determined. Anti-spoofing features may be identified based on the overlap portion. A liveness score may be generated based on the anti-spoofing features. The anti-spoofing features may be stored as an anti-spoofing template that is associated with the user. Liveness scores for subsequent inquires may be based on the anti-spoofing template. Anti-spoofing templates may be dynamically added to an anti-spoofing template library. Multiple anti-spoofing templates may be associated with a user. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a simplified block diagram of an example biometric authentication system.

FIG. 2 is a block diagram of an example prior art anti-spoofing system.

FIG. 3 is a conceptual block diagram of an example matcher based anti-spoof system.

FIG. 4 is an example of an anti-spoof system with an anti-spoofing engine for generating a liveness score.

FIG. 5 are example distortion maps and matching for a live fingerprint and a spoofed fingerprint.

FIG. 6 is an example process flow for a Fourier Transform based anti-spoofing feature extraction.

FIG. 7 is an example process flow utilizing anti-spoofing templates for liveness detection.

FIG. 8 is an example process flow for anti-spoofing model adaptation.

FIG. 9 is a block diagram of an example enroll-inquiry pairwise anti-spoofing system.

FIG. 10 is an example process flow for determining a liveness score using alignment information.

FIG. 11 is an example process flow for determining a liveness score using an anti-spoofing template.

### DETAILED DESCRIPTION

Techniques are discussed herein for improving the integrity and performance of biometric security processes on data processing devices. Biometric authentication systems may be vulnerable to presentation attacks such as spoofing where a faked input is used in an attempt to simulate a biometric feature of a live user. For example, in a facial biometric application or iris based authentication system, a fraudster may attempt to use a non-live image to impersonate a live user. In fingerprint based systems, a material such as gelatin or wood glue may be used to produce a spoofed finger print. In general, liveness detection techniques are used to determine whether a biometric input is based on a live human being or a spoofed representation. The techniques herein are directed toward improving liveness detection.

In an effort to highlight the concepts of the present matcher based anti-spoofing system, a fingerprint detection system will be used as an example. The matcher based anti-spoofing system, however, is not so limited as the concepts may apply to other liveness detection application such as facial and iris recognition systems. Current fingerprint liveness detection systems are configured to acquire images to build a large database of live biometric inputs as well as non-live fingerprints such as spoofed fingerprints of different materials. A current liveness system may pass previously stored images through a machine learning classifier to develop a liveness model. When a user subsequently desires access the system, the biometric input (e.g., fingerprint, facial or iris scan) is compared to the liveness model.

The current liveness detection system often have unacceptably high error rates because the liveness models are generally based on inputs from multiple users (i.e., generic models). The error rates may be inconsistent from user to user because human anatomy and finger behavior changes from person to person. For example, some users may have colder fingers due to frost bite or Raynaud's disease. The finger coupling to a sensor may vary based on changing skin moisture for different users. The physiology of each user's fingers may vary such that some parts of a finger may touch part of a sensor for some users but not for other users. Even for the same user, finger behavior may change based on the time of day and/or time of the year (e.g., winter/summer). Because of these variations, generic model based liveness algorithms can realize only a certain amount of accuracy. Typically, current models have an Equal Error Rate (EER) of around 10-15%. The matcher based anti-spoofing system described herein utilizes an adaptive anti-spoofing techniques for each user and finger. These adaptive anti-spoofing techniques improve the accuracy of liveness detection models as compared to the current generic model based algorithms.

In an example, the matcher based anti-spoof system describe herein receives an initial biometric input from a user (e.g., a fingerprint, voice sample, facial image, etc.) during enrollment. The biometric input may be in the form of a signal such as image (i.e., two-dimensional signal), a time dependent signal (i.e., voice sample), or other electronic signals associated with a biometric input. The biometric features are stored as a template in an enrollment database. In general, a template is a compact but expressive representation used to facilitate matching of the biometric input. For example, a template may be a digital representation of a biometric input that processed by a feature extractor. When the user subsequently attempts to access the system, the biometric input is entered for authenticate as an inquiry. The features in inquiry are compared to the features stored in enrollment database with a matching algorithm. If the features in the inquiry are the same or similar, then a matching score is generated and compared to threshold value. If a match does not happen (e.g., matcher score is lower then the threshold value), then access is denied and the liveness detection is not determined. If the match is accepted, then an area of overlap between the enrollment data and the inquiry data is determined. This overlap defines a common area between the enrollment signal and the inquiry signal. Liveness features are extracted from the common area in both signals. A matching algorithm may be used on the common areas of the two signals (e.g., enrolled and inquiry images). In an example, distortions such as global and local deformations, and finer feature correlations (e.g., third dimension/depth) on the two signals may be used to determine a liveness score to indicate whether the inquiry image is from a live person or a spoof. The common areas of the enrollment signal and a live inquiry signal may be stored in a liveness database as an anti-spoofing template and used for subsequent inquiries. The liveness score may be fused with the matcher score in an authentication system.

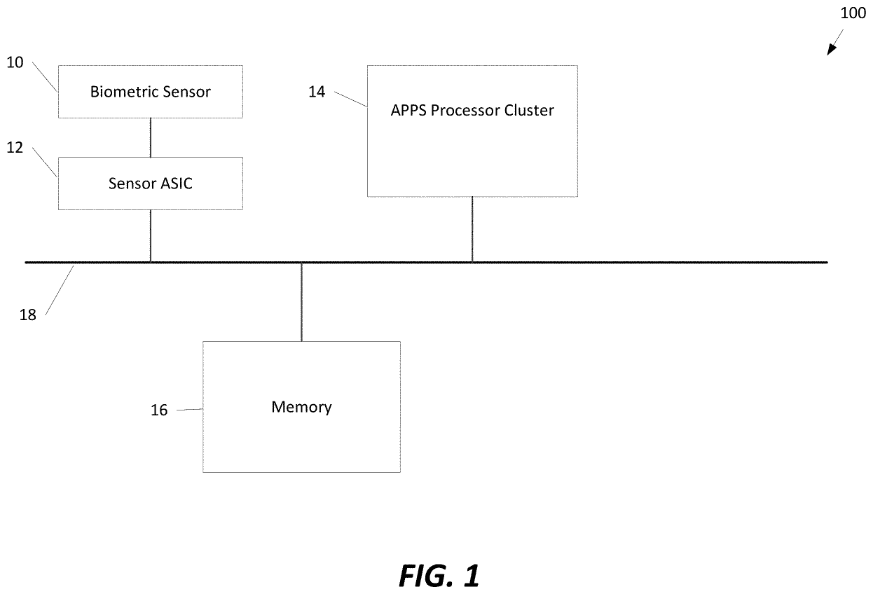

Referring to FIG. 1, a simplified block diagram of an example biometric authentication system 100 is shown. The biometric authentication system 100 includes a biometric sensor 10, a sensor Application-Specific Integrated Circuit (ASIC) 12, a memory 16, an applications (APPS) processor cluster 14, and a bus 18. The biometric authentication system 100 may be a System on Chip, and may be part of a larger data processing device (e.g., smartphone, tablet, computer, appliance, etc.). In an example, the APPS processor cluster 14 may be multiple processing units installed on one or more Printed Circuit Boards (PCB). The biometric sensor 10 and the sensor ASIC 12 may include iris or retina eye-scan technology, face technology, hand geometry technology, spectral biometric technology, and fingerprint technology, for example. To the extent the present description describes fingerprint-based systems, such description is intended to be but one example of a suitable system. The scope is not so limited. Examples of a biometric sensor 10 may include optical, injected radio frequency (RF), ultrasound sensors, or capacitive scanner disposed in a housing which provides a contact area where placed or swiped fingerprints are captured. The APPS processor cluster 14 may comprise multiple processors. In an example, the APPS processor cluster 14 may also include a Trusted Execution Environment (TEE) such as the ARM TrustZone® technology which may be integrated into the APPS processor cluster 14. The memory 16 may be double data rate synchronous dynamic random-access memory (DDR SDRAM). The APPS processor cluster 14 may be configured to read and write to the memory 16 via the bus 18.

In operation, the memory 16 may be configured to store one more enrollment templates in an enrollment database. The APPS processor cluster 14 may be configured to execute matching algorithms to compare inquiry images with enrollment images. As used herein, an image is an example of a signal, and more particularly, a two-dimensional signal. The memory 16 and APPS processor cluster 14 may also be configured to store anti-spoofing templates and perform the functions of the anti-spoofing matcher described herein.

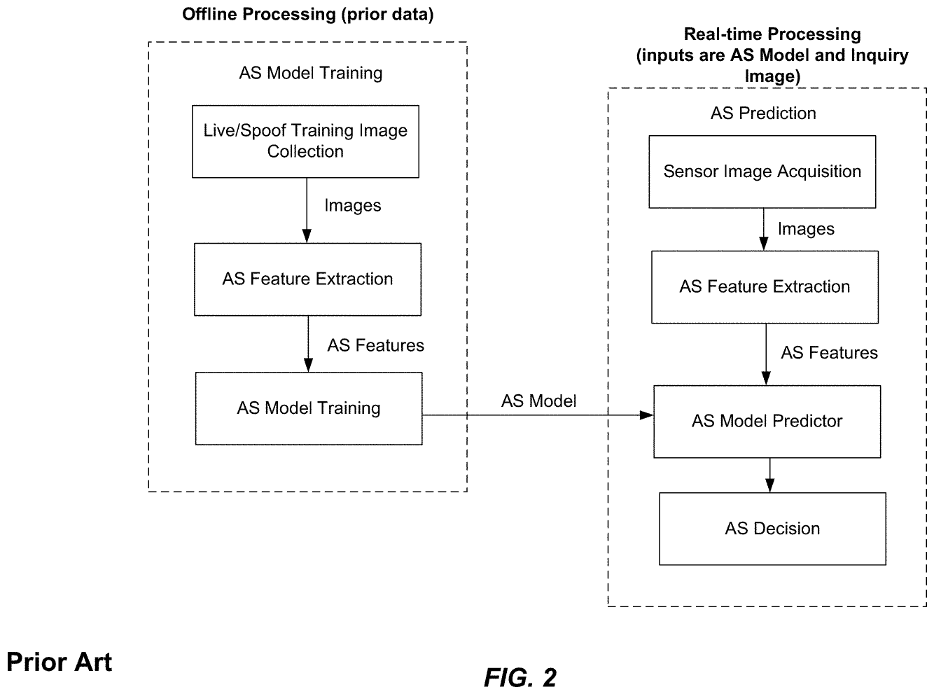

Referring to FIG. 2, an example of a prior art anti-spoofing system is shown. The prior art systems generally rely on offline processing to generate anti-spoofing (AS) models which are then used in a real-time processing system. The offline processing may store a collection of images of live and spoofed images as a repository for machine learning algorithms. The offline processing may include algorithms for anti-spoofing feature extraction to identify feature descriptors that are present in live and/or spoofed images. The result of the offline processing is a collection of anti-spoofing models which are available for use in a real-time application. A real-time processing application may be configured to receive a sensor image and perform anti-spoofing feature extraction on the sensor images. An anti-spoofing model predictor module may be configured to utilize the anti-spoofing features extracted from the live image and the previously computed anti-spoofing model received from the offline source to make an anti-spoofing decision (e.g., a liveness score). An issue with such an approach is that the anti-spoofing models generated by offline processing are based on training images for multiple users (e.g., a crowd) and thus are prone to inaccurate. For example, a system based on offline anti-spoofing models may have an Equal Error Rate (EER) of around 10-15%, meaning 10-15% of spoofed inputs will be accepted. Thus, there is a need to improve the accuracy of anti-spoofing decisions.

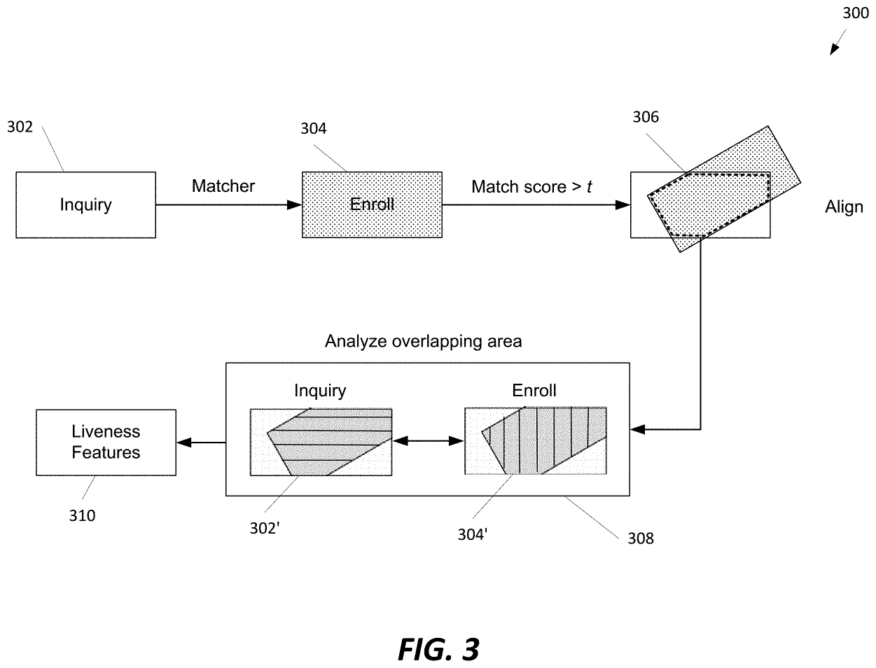

Referring to FIG. 3, a conceptual block diagram of an example of a matcher based anti-spoofing system 300 is shown. The system 300 utilizes inquiry image information 302 and enrollment image information 304 and determines an overlap area 306 between the two. A liveness algorithm 308 is configured to analyze an inquiry image information overlap area 302′ (i.e., the overlap area 306 as applied to the inquiry image information 302) and an enrollment image information overlap area 304′ (i.e., the overlap area 306 as applied to the enrollment image information 304). The liveness algorithm 308 is configured to output one or more liveness features 310 based on the overlap areas 302′, 304′.

In operation, a user may provide the enrollment image information 304 during an initial enrollment on a device. For example, the biometric sensor 10 may be configured to receive a fingerprint image and the APPS processor cluster 14 is configured to store a user specific enrollment template in an enrollment database in the memory 16. The enrollment image information 304 may be based on the user specific enrollment template in the enrollment database. The user may provide the inquiry image information 302 in a subsequent attempt to access the device. For example, the user may present the same finger to the biometric sensor 10. The APPS processor cluster 14 is configured to execute a matching algorithm between the inquiry image information 302 and the enrollment image information 304. The matching algorithm may be configured to match keypoints and descriptors (e.g., gradient, local binary pattern (LBP), etc.) or other minutiae and/or ridge feature based techniques (e.g., based on level 2 & 3 features and descriptors, deformation matrix). The matching algorithm may be configured to determine a matcher score as a basis for determining whether the inquiry and enrollment information match. Typically, the resulting matcher score is compared to a threshold value (t) to determine that there is a match. If the matcher score meets the threshold expectations, the matching algorithm is configured to determine the overlap area 306. The inquiry and enrollment information may be rotated or translated from one another and the matcher is configured to align the two to determine the overlap area 306 and provide the alignment information (e.g., rotation, translation and shear).

In an example, the alignment information and features extracted from the overlap areas 302′, 304′ are used to generate the liveness features 310. The liveness features may include ridge-valley contrast, ridge-valley thickness ratio, and ridge continuity. In general, the overlap area 306 may be considered as a liveness feature in that the inquiry image and the enrollment image are used jointly as compared to the prior art system which rely upon only the features in the inquiry image as compared to offline anti-spoofing models.

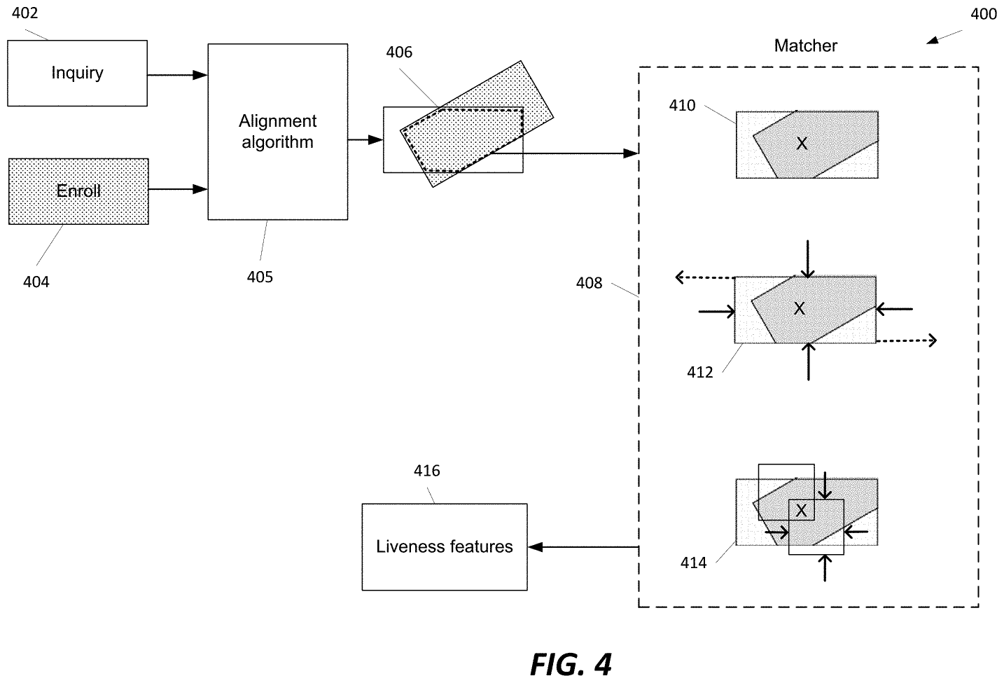

Referring to FIG. 4, an example of anti-spoof system 400 with an anti-spoofing engine 408 for generating a liveness score is shown. The system 400 provides inquiry image information 402 and enrollment image information 404 to an alignment algorithm 405. The inquiry image information 402 may be based on an input from a biometric sensor 10 and the enrollment image information 404 may be retrieved from an enrollment database based on the user providing the inquiry image information 402. The alignment algorithm 405 may be part of a matching algorithm and configured to determine alignment features between the inquiry image information 402 and the enrollment image information 404. The alignment features may include rotation, translation and shear variables (e.g., x, y, θ). The alignment algorithm 405 is also configured to determine a common area 406 between the inquiry image information 402 and the enrollment image information 404. While the common area 406 depicted in FIG. 4 is illustrated as an area (e.g., in two dimensions), a common area or overlap area is not so limited. The common area 406 may be a common segment along a time axis, or other suitable overlapping portions of two signals. In an example, the common area 406 for both the inquiry image information 402 and the enrollment image information 404 are provided to the anti-spoofing engine 408. In an example, the anti-spoofing engine 408 may include a matcher. There are many matching algorithms that may be used in the anti-spoofing engine 408. The anti-spoofing engine 408 may be configured to select 1-2 foci ‘X’ from the common area at stage 410. In this example, the anti-spoofing engine 408 is configured to compare distortions in the inquiry image information 402 and the enrollment image information 404 within the common area 406. At stage 412, the image information may be stretched, squeezed and sheared to determine global distortion results. In general, live fingers and spoofs can have different distortions. Spoofs, for example, may shrink during the manufacturing process or undergo other such changes. At stage 414, the anti-spoofing engine 408 may determine local distortion results, such as contrast variations and rotations, within tiles on the common area 406. The global and local distortions determined by the anti-spoofing engine 408 may be output as the liveness features 416.

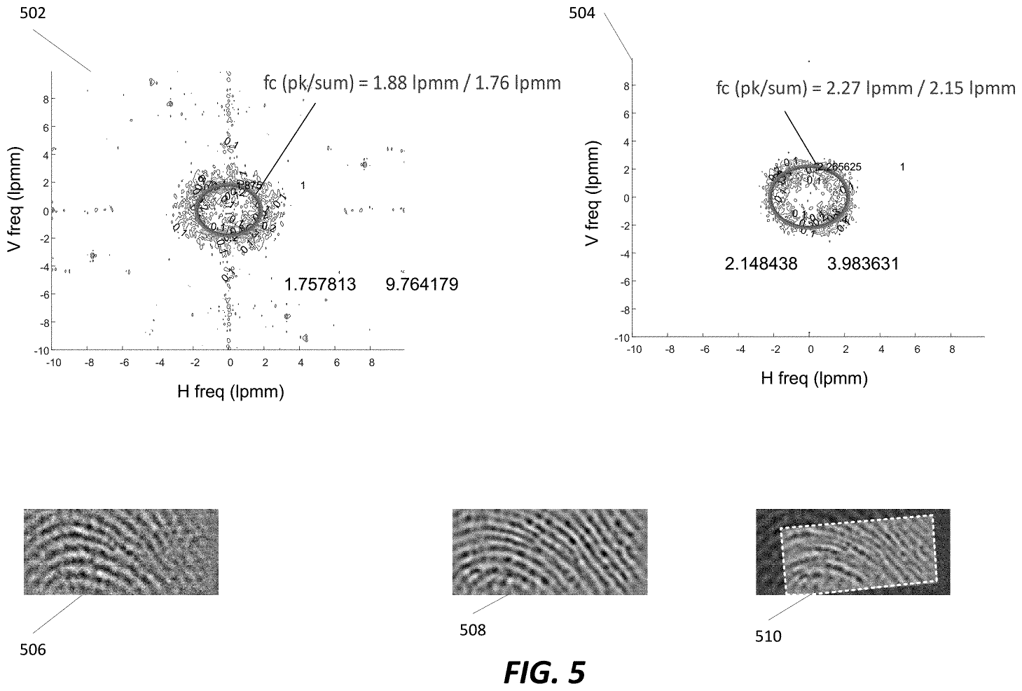

Referring to FIG. 5, with further reference to FIG. 4, example distortion maps and matching scores for a live fingerprint and a spoofed fingerprint are shown. A first distortion map 502 and a second distortion map 504 represent the feature vectors in a fingerprint image that have been mapped to a frequency space via a Fourier Transform. Specifically, an enrollment image 506 and an inquiry image 508 may be aligned in a matching algorithm (e.g., the alignment algorithm 405) to determine a common area 510. If the matching algorithm determines that the inquiry image 508 matches the enrollment image, the common area 510 of both images can be transformed and the resulting features may be analyzed by the anti-spoofing engine 408. If the matching algorithm determines there is no match between the inquiry and the enrolled images, there is no need to provide the images to the anti-spoofing engine (i.e., no match means a failed authentication). The first and second distortion maps 502, 504 include horizontal and vertical spatial frequency values expressed in line pairs per millimeter (lpmm). A line pair may include one black line and one white line. The first distortion map 502 represents the anti-spoofing feature vectors for the common area 510 of the inquiry image 508. The second distortion map 504 represents the anti-spoofing feature vectors for the common area 510 of the enrollment image 506. In this example, the inquiry image 508 is generated with a spoof and the enrollment image 506 is generated with a real finger. As indicated on the first distortion map 502, the analogy concentration for the signal is around a circle with a value of 1.88 lpmm. The second distortion map 504 indicates an analogy concentration around a circle with a value of 2.27 lpmm. In this example, the matching algorithm indicates that the inquiry image 508 matches the enrollment image 506, but the distortion maps generate by the anti-spoofing engine 408 indicate the spoof material expanded (i.e., the spatial frequency decreased) and thus provides an indication that the inquiry image 508 is a spoof. Thus, the authentication of the inquiry image 508 would fail even though the matcher indicated there was a match with the enrollment image. Other spectral characteristics of an image/signal such as fingerprint frequency, noise frequency, frequency shift, and other transformations such as rotation and scaling at different frequencies may be used by the matching algorithm.

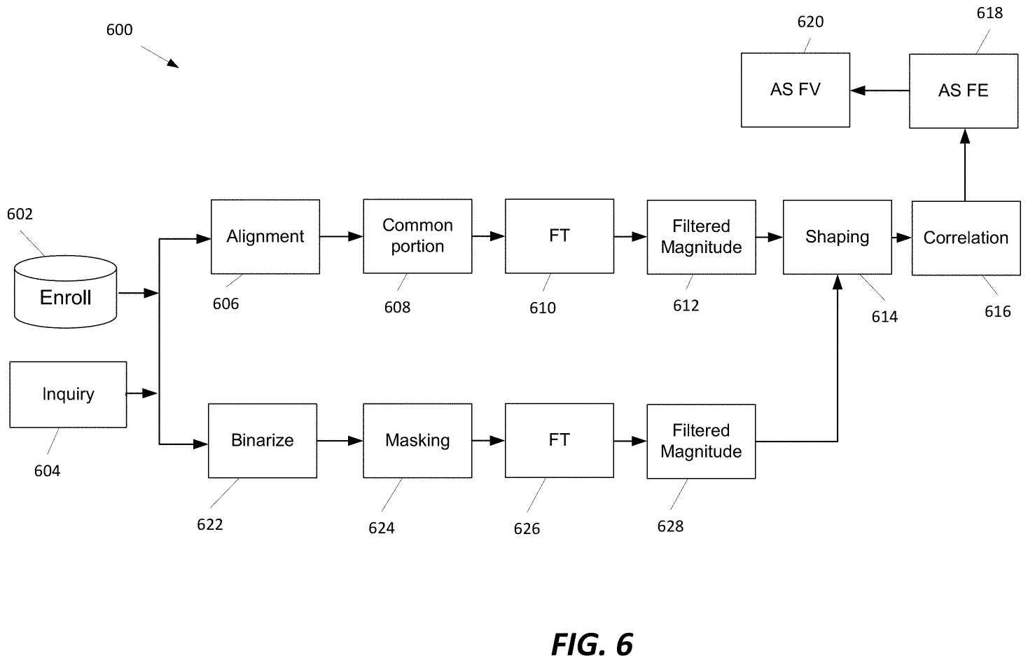

Referring to FIG. 6, with further references to FIGS. 1-5, an example process flow 600 for a Fourier Transform based anti-spoofing feature extraction is shown. The APPS processor cluster 14 may be configured to execute the process flow 600 within the biometric authentication system 100. An enrollment database 602 may persist in the memory 16, or other local or networked memory sources, and may include enrollment image information for one or more users of a device. The inquiry image information 604 may be obtained when a user attempts to access a device after providing the enrollment image information. At stage 606, the process 600 determines one or more alignment variables (e.g., x, y, θ) between the inquiry image information 604 and an enrollment image associated with the user. At stage 608, the common portion between the aligned inquiry and enrollment images is determined. In an example, the common portion may be defined as the overlapping areas within the respective inquiry and enrollment images such as the common area 406 in FIG. 4. In other examples, the common portion may be a common segment on a time axis (e.g., common in one dimension). The inquiry image and the enrollment image may be respectively masked based on the common portion and a Fourier transform of each of the masked areas may be performed at stage 610. The resulting signal after the Fourier transform may be filtered at stage 612 to determine the analogy concentrations such as depicted in the first and second distortion maps 502, 504.

In general, biometric authentication is a non-fault procedure and storing biometric images may be prohibited in an effort to improve the security of a system. Accordingly, the biometric images are typically transformed into different forms such as feature vectors. As a processing consideration, a Fourier transform is a global operation and once the image is transformed and converted to feature vectors (e.g., decimation of transformed data, discarding of phase information, etc.), it may be impracticable to recompute the common area between an inquiry image and an enrolled image. To overcome this issue, binary images are generated at stage 622 for the inquiry and enrollment images, and a masking process at stage 624 is performed based on the overlap of the binary images. A Fourier transform is performed on the binary image at stage 626 and the analogy concentrations are determined at stage 628. At stage 614, a shaping process utilizes the analogy information from the binary image to determine where the analogies are located and then shapes the spectrum from a real finger. The shaping is used to optimize the template size.

After shaping at stage 624, various correlations may be performed on the inquiry and enrollment spectral magnitudes at stage 616. The spectral magnitude correlations may be simple correlations based on the images. The correlations may be based on feature extractions from the signal which are then passed to a classifier. At stage 616, the anti-spoofing features based on ridge-valley contrast, ridge-valley thickness ratio, ridge continuity, correlations at different spatial frequencies, rotation of radial spectral lines, noise characteristics at different spectral frequencies, etc., may be extracted at stage 618 and stored as anti-spoofing feature vectors at stage 620. For successful inquiry images, the resulting anti-spoofing feature vectors generated by the process 600 may be stored in a database as anti-spoofing templates.

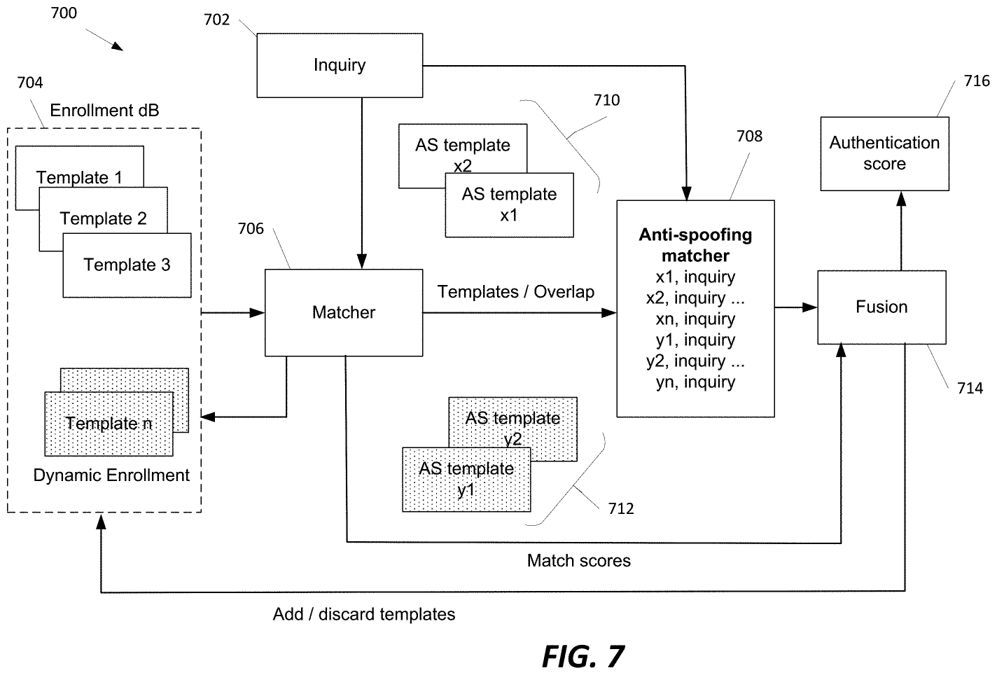

Referring to FIG. 7, and example process 700 utilizing anti-spoofing templates for liveness detection is shown. The biometric authentication system 100 is an example of a means for implementing the process 700. At stage 702, an inquiry image may be obtained via the biometric sensor 10. The APPS processor cluster 14 is configured to receive the inquiry image and at least one template from an enrollment database 704 and then execute a matching algorithm at stage 706. The matching algorithm is configured to determine alignment parameters and overlap area of the inquiry image and each of the one or more templates retrieved from the enrollment database. In general, the matching algorithm may pre-align fingerprint images according to a landmark or other point (e.g., a center point/core). In an example, the matching algorithm at stage 706 may be configured as a correlation based matcher where the inquiry and enrollment images are superimposed and the correlation between corresponding pixels is computed for different alignments (e.g., different displacements and rotation angles). The matching algorithm may be a minutiae-based matcher where the minutiae are extracted from the inquiry and enrollment fingerprints and stored as sets of points in a two-dimensional plane. The alignment may be determined by finding the maximum number pairings between the inquiry and enrollment points in the two-dimensional plane. The matching algorithm may be a ridge feature-based matcher where the inquiry and enrollment fingerprints are compared in terms of the features extracted from the fingerprint ridge patterns. The matching algorithm at stage 706 may vary based on other types of biometric input (e.g., voice, iris, facial, etc.). In an embodiment, successful inquiry image information (i.e., inquiry images which match one or more enrolled templates) may be added to the enrollment database as a new template (i.e. Template n) in support of a dynamic enrollment process.

The matching algorithm at stage 706 is configured to provide the successfully matching templates and corresponding overlap areas to an anti-spoofing matcher at stage 708. The overlap areas correspond to the common area 406 between the inquiry image and the enrollment image, as depicted in FIG. 4. The overlap area of an enrollment image may be stored as an anti-spoofing template 710. The anti-spoofing templates may include the features within the overlap area as well as the alignment parameters associated with a matching inquiry. The inquiry image obtained at stage 702 may be provided to the anti-spoofing matcher at stage 708. The anti-spoofing matcher may be configured to determine an overlap area on the inquiry image based on the overlap areas stored in the anti-spoofing templates 710. In an example, the anti-spoofing matcher at stage 708 may be configured to transform the common area inquiry image information and anti-spoofing templates 710 to the frequency domain via a Fourier transform to determine a liveness score based on a comparison of analogy configurations as depicted in FIG. 5. Other liveness detection algorithms may also be used. In an example, a fingerprint image may contain several localized feature points that may demonstrate the liveness of fingers. Features vectors may be based on pore distribution, ridge sharpness, and geometry of the ridge-valley boundary that may be too small to be copied by a fake finger (e.g., wax, clay, silicone, etc.). Historical images (e.g., prior biometric scans of a user) may be analyzed to detect changes over time. Liveness detection may rely on other sensors (e.g., body temperature, a facial recognition device, keypad input, amplitude scan, fingerprint depth map). These features and sensor information may be included in the anti-spoofing templates 710.

The anti-spoofing matcher at stage 708 may be configured to store dynamic anti-spoofing templates 712 based on successfully matching the common area of an inquiry image information with one or more anti-spoofing templates. Such dynamic anti-spoofing templates 712 may be used with future inquiry images to determine a liveness score. The anti-spoofing templates 710 and the dynamic anti-spoofing templates 712 may be stored in a liveness database within the memory 16. In an example the anti-spoofing templates 710 and the dynamic anti-spoofing templates 712 may be stored in the enrollment database 704. The anti-spoofing templates 710, 712 may be associated with a user (e.g., userID field) to enable a personalized liveness detection. For example, the anti-spoofing templates 710, 712 may be associated with a particular user and the anti-spoofing matcher at stage 708 is configured to iterate through the different templates associated with the user (e.g., x1, x2, . . . , xn, y1, y2, . . . , yn). Thus, the liveness scores generated by the anti-spoofing matcher at stage 708 may be personalized in that they are based on various user/finger and sensor characteristics for individual users as compared to liveness scores that are generated based on global (i.e., based many different users) liveness factors.

At stage 714, the APPS processor cluster 14 may be configured to fuse a matcher score generated by the matching algorithm at stage 706 and a liveness score generated by the anti-spoofing matcher at stage 708. For example, the APPS processor cluster 14 may be configured to authenticate the received biometric information (e.g., fingerprint scan) at stage 716 based on the fused (e.g., combined) matcher and liveness scores. Predetermined thresholds may be established for each score individually or in combination, and an authentication is verified (i.e., approved) if the score(s) are greater than the threshold. Other statistical methods may be used to validate the matcher and liveness scores. For successful inquiries, the enrollment database may be appended to include the a new template based on the inquiry image information (i.e., dynamic enrollment). Conversely, previously enrolled templates may be deleted from the enrollment database if an inquiry fails authentication.

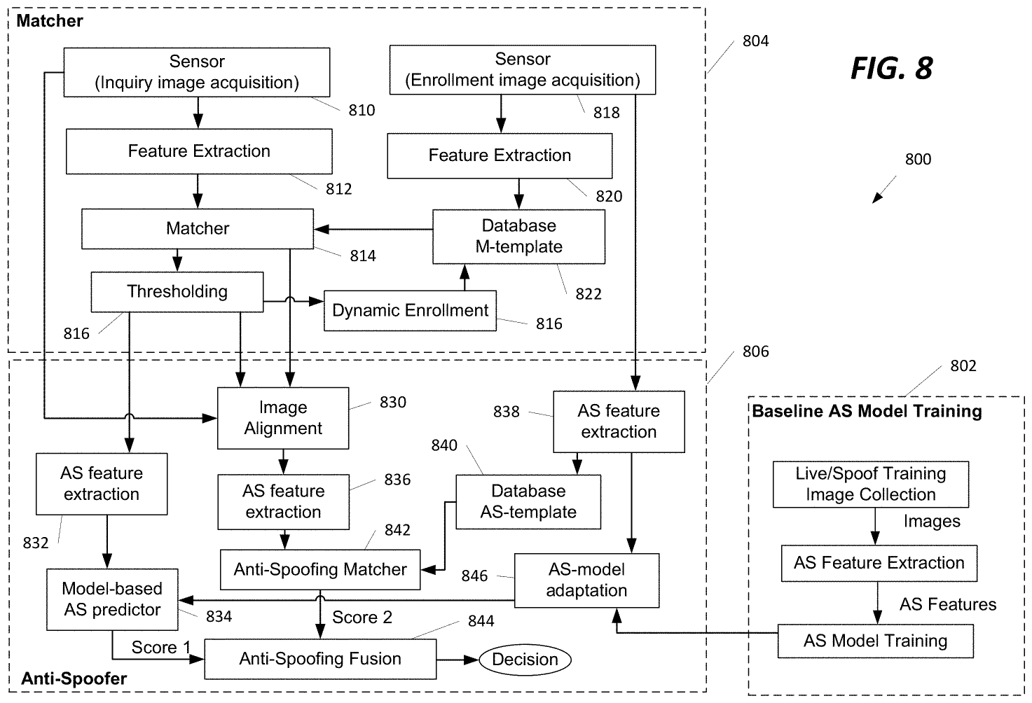

Referring to FIG. 8, with further references to FIGS. 1-7, and example process 800 for anti-spoofing model adaptation is shown. The process 800 includes a baseline anti-spoofing model training module 802, a matcher module 804, and an anti-spoofer module 806. The baseline anti-spoofing model training module 802 can be a prior-art anti-spoofing system such as described in FIG. 2 and configured to generate anti-spoofing (e.g., liveness) models to the anti-spoofer module 806. In general, the anti-spoofing models generated by the training module 802 are based on global image collection which include images from multiple users. The matcher module 804 includes a first sensor stage 818 for acquiring one or more biometric inputs such as a fingerprint image during user enrollment. A second sensor stage 810 is configured acquiring biometric inputs during subsequent inquiries by the user. Both the first and second sensor stages 818, 810 may utilize the same biometric sensor, such as the biometric sensor 10 of FIG. 1. A first feature extraction stage 820 and a second feature extraction stage 812 are configured to generate templates from the biometric sensor input. In an example, the feature extraction stages 820, 812 receive the digital data from a sensor and may compact that data by generating feature vectors which are stored as templates. A user identification value may be associated with templates. During enrollment, the templates may be stored in an enrollment database at stage 822. The enrollment database may contain a collection of matching templates (i.e., M-templates) for one or more users. The feature vectors in the M-templates are compared with the feature vectors generated by the second feature extraction stage 812 in a matching algorithm at stage 814. The matching algorithm may be configured to determine alignment parameters and an overlap area of the inquiry image and each of the one or more templates in the enrollment database. For a fingerprint, the matching algorithm may pre-align fingerprint images according to a landmark or other point (e.g., a center point/core). In an example, the matching algorithm may be configured as a correlation based matcher where the inquiry and enrollment images are superimposed and the correlation between corresponding pixels is computed for different alignments (e.g., different displacements and rotation angles). The matching algorithm may be a minutiae-based matcher where the minutiae are extracted from the inquiry and enrollment fingerprints and stored as sets of points in a feature vector. The alignment may be determined by finding the maximum number pairings between the inquiry and enrollment points in the respective feature vectors. The matching algorithm may be a ridge feature-based matcher where the inquiry and enrollment fingerprints are compared in terms of the feature vectors associated with the fingerprint ridge patterns. The matching algorithm may vary based on other types of biometric input (e.g., voice, iris, facial, etc.).

The matching algorithm may output one or more matcher scores indicating the strength of the match between an inquiry image and a respective M-template from the enrollment database. The matcher scores may be compared to a threshold value at stage 816. The threshold value may be adjusted based on the security requirements of an application or other context related criteria. For example, location based thresholds may be used such that a lower threshold is used for a user's home and higher thresholds may be used when a device is located in a public area.

The anti-spoofer module 806 may be configured to determine alignment variables such as rotation, translation and shear variables (e.g., x, y, θ) between an inquiry template and a M-template at stage 830. In an example, the alignment variables may be determined by the matching algorithm at stage 814. In addition to image alignment, the anti-spoofer module 806 may be configured to determine an overlap area (i.e., common area) between the inquiry template and the M-template. The inquiry image obtained at stage 810 may also be used in determining the alignment variables and the overlap area at stage 830. The anti-spoofing features in the overlap area for both the inquiry template and the M-template may be extracted at stage 836. The anti-spoofing features may be liveness features such as ridge-valley contrast, ridge-valley thickness ratio, and ridge continuity. The overlap area may be considered as one large anti-spoofing feature because the inquiry image and the enrollment image are used jointly in the anti-spoofing matcher at stage 842. In contrast, anti-spoofing features of the inquiry image alone may be determined at stage 832 and compared to model-based anti-spoofing features at stage 834. The model-based anti-spoofing features are based the anti-spoofing models generated in the baseline anti-spoofing model training module 802 as adapted at stage 846. At stage 844, the anti-spoofer module 806 is configured to fuse a model based anti-spoofing score (i.e., ‘Score 1’) which was generated at stage 834, and the anti-spoofing matcher score (i.e., ‘Score 2’) which was generated at stage 842. The fused anti-spoofing scores may be used in the liveness decision for the inquiry image.

The anti-spoofer module 806 is configured to adapt liveness models for a wide range of operational requirements. For example, at stage 838 the anti-spoofing features contained in the enrollment images obtained at stage 818 may be extracted and stored as anti-spoofing templates in a database at stage 840. Since the enrollment images are considered to be live, each enrollment may increase the number of anti-spoofing templates in the database. In an embodiment, the anti-spoofing features of a successful inquiry may also be added to anti-spoofing template database (i.e., dynamic enrollment for anti-spoofing templates). The anti-spoofing templates may include image based features in the overlap area as well as features derived from other data processing transformations such as a Fourier transform.

Machine learning algorithms may be used to capture anti-spoofing features such as image information (e.g., ridge-valley contrast, ridge-valley thickness ratio, and ridge continuity), sensor temperature, and other sensor input. Other context and user behavior and/or usage patterns may also be used. The anti-spoofing features may be associated with a particular user, finger, sensor, or other user preferences and device hardware options. The machine learning algorithms utilize such anti-spoofing features and the enrollment images to adapt the baseline anti-spoofing models at stage 846. The adapted models represent customizations of the global baseline models for specific users and other operational/context variables.

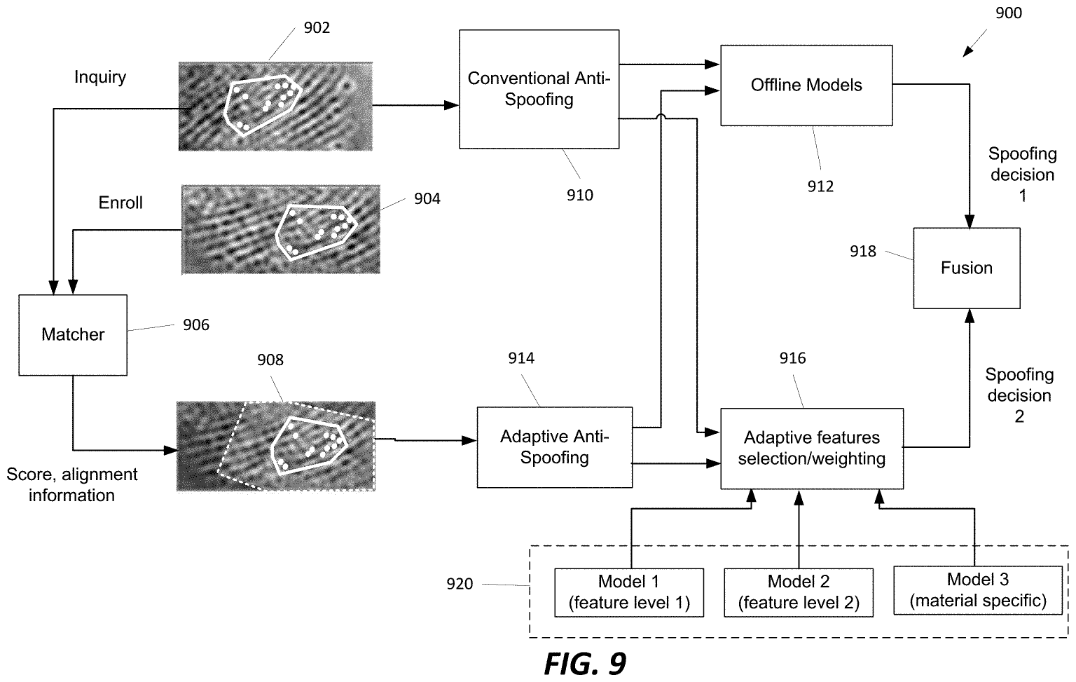

Referring to FIG. 9, a block diagram 900 of an example enroll-inquiry pairwise anti-spoofing system is shown. The diagram 900 includes an inquiry image 902 and an enrollment image 904. The images 902, 904 may be obtained via a biometric sensor 10. The enrollment image 904, or feature vectors representing the enrollment image 904, may be stored in the memory 16 or other local or network memory source. A matcher 906 is configured to perform a matching algorithm on the inquiry image 902 and the enrollment image 904.

In a fingerprint example, the inquiry image 902 may include global level features such as entropy, patterns such as lines and circles, frequency and other artifacts. Such global features may be provided to a conventional anti-spoofing algorithm 910 to catch specific frame level artifacts left by spoof material that are independent of the user/finger. The global level features may be provided to an offline models module 912 to be used in generating a first spoofing decision. The global level features may also be provided to an adaptive feature weighting module 916 to be used in generating a second spoofing decision.

An adaptive anti-spoofing algorithm 914 may receive the overlap areas 908 for the inquiry image 902 and the enrollment image 904 from the matcher 906. From these overlap areas 908, the adaptive anti-spoofing algorithm 914 extracts fine-level features which may be used in the adaptive feature weighting module 916. These fine features indicate how features of real fingers (users) diverge from spoofs. The fine features may be device/sensor and user/finger specific. The fine features may also be provide to the offline models module 912 to be used in the generation in the first spoofing decision. The adaptive feature weighting module 916 may receive feature and material specific model information 920 associated with anti-spoofing features (e.g., feature level 1, feature level 2) and anti-spoofing materials. The adaptive feature selection/weighting enables a device to customize a liveness solution for individual users. A fusion module 918 may be used to determine a liveness decision based on first and second spoofing decisions. The decision may be based on each score individually (as compared to respective threshold values) or in combination (as compared to a single threshold value).

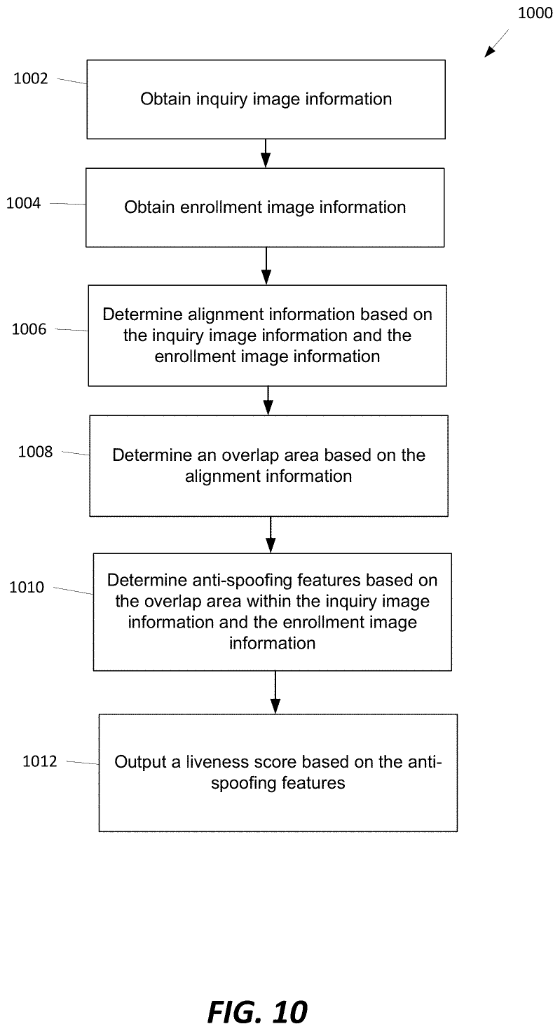

Referring to FIG. 10, with further reference to FIGS. 1-9, a method 1000 for determining a liveness score using alignment information includes the stages shown. The method 1000 is, however, an example only and not limiting. The method 1000 may be altered, e.g., by having stages added, removed, rearranged, combined, performed concurrently, and/or having single stages split into multiple stages. For example, stage 1004 described below for obtaining enrollment image information can be performed before stage 1002. The image information in the method 1000 may be a two-dimensional signal representing two dimensions in space. The image information may be other signals, such as time-based signals utilized in voice recognition and video/screen capture systems. Still other alterations to the method 1000 as shown and described are possible.

At stage 1002, the method includes obtaining inquiry image information. The biometric sensor 10 may be a means for obtaining inquiry image information. In an example, the inquiry image information is an image of a biometric features such as a fingerprint, iris, face, or other unique biometric feature that may be obtained by a sensor. The inquiry information may be a template based on the results of a feature extraction process on a raw biometric input (e.g., a fingerprint image). The inquiry image information may be associated with a user that is attempting to gain access to secure device.

At stage 1004, the method includes obtaining enrollment image information. The biometric sensor 10, along with the memory 16 and the APPS processor cluster 14 may be a means for obtaining enrollment image information. The enrollment image information may be obtained from a user during a set-up sequence for a secure device. The user may provide one or more biometric inputs to one or more biometric sensors 10 and the associated biometric information may be stored in the memory 16. In an example, the APPS processor cluster 14 may be configured to execute one or more feature extraction algorithms on an enrollment image to produce an enrollment template. The enrollment templates may be stored in an enrollment database. In general, secure systems avoid storing images in memory in an effort to prevent identity theft. The enrollment templates may be a digital representation of a biometric input that was processed by a feature extractor. The enrollment image information may be obtained by retrieving enrollment templates associated with a user that is providing inquiry information at stage 1002.

At stage 1006, the method includes determining alignment information based on the inquiry image information and the enrollment image information. The APPS processor cluster 14 may be a means for determining the alignment information. For example, the APPS processor cluster 14 may be configured to execute a matching algorithm between the inquiry image information obtained at stage 1002 and the enrollment image information obtained at stage 1004. The matching algorithm may be configured to match key points and descriptors (e.g., gradient, local binary pattern (LBP), etc.) or other minutiae and/or ridge feature based techniques (e.g., based on level 2 & 3 features and descriptors, deformation matrix). The inquiry and enrollment information may be rotated or translated from one another and the matcher is configured to align the two to determine the alignment information (e.g., rotation, translation and shear).

At stage 1008, the method includes determining an overlap area based on the alignment information. The APPS processor cluster 14 may be a means for determining the overlap area. The matching algorithm used in stage 1006 may also be configured to determine the overlap area between the inquiry image information and the enrollment image information based in part on the alignment information. Referring to FIG. 3, the overlap area 306 includes the areas within the inquiry image information and the enrollment image information that match after the alignment process. In general, determining the alignment information and the overlap area is predicated on the inquiry image information and the enrollment image information matching to an acceptable level (e.g., above a desired threshold value).

At stage 1010, the method includes determining anti-spoofing features based on the overlap area within the inquiry image information and the enrollment image information. The APPS processor cluster 14 may be a means for determining anti-spoofing features. In an example, the alignment information and features extracted from the overlap area as applied to each of the inquiry image information and the enrollment image information may be used to determine anti-spoofing features. The anti-spoofing features may also be referred to as liveness features. For example, the anti-spoofing or liveness features may include ridge-valley contrast, ridge-valley thickness ratio, and ridge continuity information in the inquiry and enrollment image information. The anti-spoofing features may also include noise patterns (e.g., lines and circles), noise characteristics (e.g., frequency, amplitude), and other signal characteristics (e.g., other fingerprint features, local and global deformation result or other transformations). In an example, the APPS processor cluster 14 may be configured as the anti-spoofing engine 408 in FIG. 4, and may include a matcher. The APPS processor cluster 14 may be configured to compare distortions in the inquiry image information and the enrollment image information within the overlap area. The image information may be stretched, squeezed and sheared to determine global and local distortions. The spatial data in the inquiry and enrollment image information may be transformed to the frequency domain to generate distortion maps. For example, the spectral characteristics of an image/signal may include fingerprint frequency, noise frequency, frequency shift, and other transformations such as rotation and scaling at different frequencies. A comparison of the distortion maps, such as in FIG. 5, may be used to determine anti-spoofing features.

At stage 1012, the method includes outputting a liveness score based on the anti-spoofing features. The APPS processor cluster 14 may be a means for outputting the liveness score. In an example, the anti-spoofing features may be identified in a comparison of analogy points in the frequency domain (e.g., distortion maps). The liveness score may be based on the corresponding matching score. Other liveness scoring schemes may also be used with the anti-spoofing features determined at stage 1010. For example, Local Binary Pattern (LBP) operations and Support Vector Machine (SVM) classifiers may be used with the anti-spoofing features to determine a liveness score. The liveness score may be output to a fusion module in an authentication system to combine with a matcher score. In an example, the liveness score and anti-spoofing features may be output to a machine learning algorithm to generate adaptive liveness models. In an embodiment, the anti-spoofing features may be saved as liveness templates and used in future authentication and/or liveness detection. The liveness template may be associated with a user and a particular finger and compared to the anti-spoofing features determined at stage 1010. As a result, the liveness score may also be based on matching the anti-spoofing features for a particular finger with a corresponding liveness template that was stored after a previous inquiry.

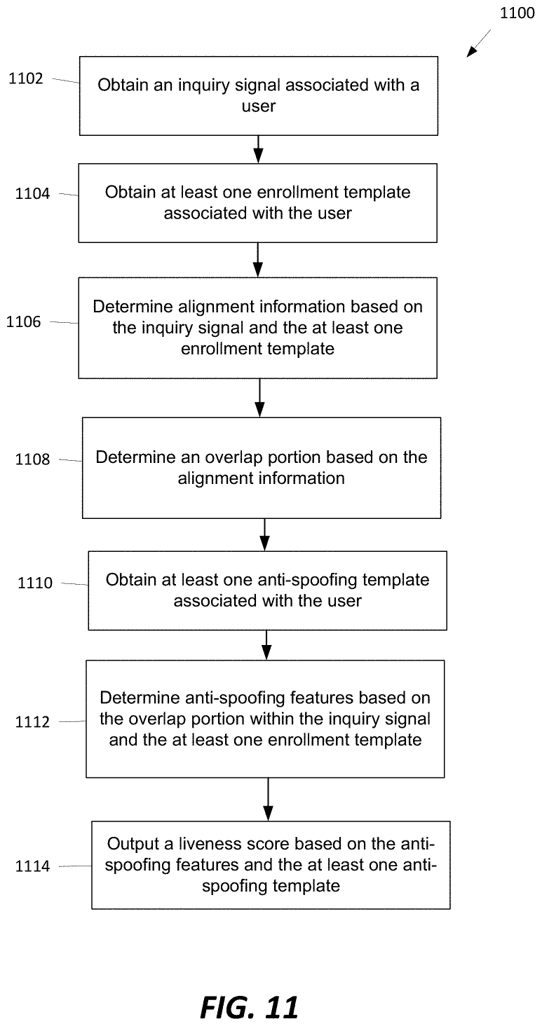

Referring to FIG. 11, with further reference to FIGS. 1-9, a method 1100 for determining a liveness score using an anti-spoofing template includes the stages shown. The method 1100 is, however, an example only and not limiting. The method 1100 may be altered, e.g., by having stages added, removed, rearranged, combined, performed concurrently, and/or having single stages split into multiple stages. For example, stage 1104 described below for obtaining at least one enrollment template associated with a user can be performed before stage 1102. The inquiry signal in the method 1100 may be an image (e.g., a two-dimensional signal representing two dimensions in space), other signals such as time based signals utilized in voice recognition. Still other alterations to the method 1100 as shown and described are possible.

At stage 1102, the method includes obtaining an inquiry signal associated with a user. The biometric sensor 10 may be a means for obtaining an inquiry signal. In an example, the inquiry signal is an image of a biometric features such as a fingerprint, iris, face, or other unique biometric feature that may be obtained from the user by a sensor. The inquiry signal may be processed by a feature extraction process to generate a template.

At stage 1104, the method includes obtaining at least one enrollment template associated with the user. The biometric sensor 10, along with the memory 16 and the APPS processor cluster 14 may be a means for obtaining at least one enrollment template. An enrollment template may be based on enrollment image information obtained from a user during a set-up sequence for a secure device. The user may provide a user information (e.g., userID) and one or more biometric inputs to one or more biometric sensors 10 and the associated biometric information may be stored in the memory 16. In an example, the APPS processor cluster 14 may be configured to execute one or more feature extraction algorithms on an enrollment image to produce an enrollment template. The enrollment templates may be stored in an enrollment database and indexed by the user information. In general, secure systems avoid storing images in memory in an effort to prevent identity theft. The enrollment templates may be a digital representation of a biometric input that was processed by a feature extractor.

At stage 1106, the method includes determining alignment information based on the inquiry signal and the at least one enrollment template. The APPS processor cluster 14 may be a means for determining the alignment information. For example, the APPS processor cluster 14 may be configured to execute a matching algorithm between a template based on the inquiry signal obtained at stage 1102 and the at least one enrollment template obtained at stage 1104. The matching algorithm may be configured to match key points and descriptors (e.g., gradient, local binary pattern (LBP), etc.) or other minutiae and/or ridge feature based techniques (e.g., based on level 2 & 3 features and descriptors, deformation matrix). The inquiry and enrollment templates may be rotated or translated from one another and the matcher is configured to align the two to determine the alignment information (e.g., rotation, translation and shear).

At stage 1108, the method includes determining an overlap portion based on the alignment information. The APPS processor cluster 14 may be a means for determining the overlap portion. The matching algorithm used in stage 1006 may also be configured to determine at least one overlap portion between the inquiry signal template and the at least one enrollment template based in part on the alignment information. In an example, referring to FIG. 3, the overlap portion may include the overlap area 306 based on the areas within the inquiry template and the enrollment template that match after the alignment process. The overlap portion need not be a two-dimensional area for other signals, such as time-based signals, or signals with more than two-dimensional variables. In general, determining the alignment information and the overlap portion is predicated on the inquiry image information and the enrollment image information matching to an acceptable level (e.g., above a desired threshold value).

At stage 1110, the method includes obtaining at least one anti-spoofing template associated with the user. The APPS processor cluster 14 may be a means for obtaining the at least one anti-spoofing template. A liveness database may include a collection of anti-spoofing templates, where each anti-spoofing templates may include the features extracted from prior overlap areas for both the inquiry templates and the enrollment templates, as well as the corresponding alignment parameters. The anti-spoofing templates may be associated with a user and/or a particular enrollment template obtained at stage 1104. In an example, the anti-spoofing templates may include analogies in the frequency domain based on transformations of prior inquiry and enrollment images. The anti-spoofing templates may include other liveness features vectors in prior inquiry and enrollment images. The liveness feature vectors may describe localized feature points that may demonstrate the liveness of fingers. For example, pore distribution, ridge sharpness, and geometry of the ridge-valley boundary that may be too small to be copied by a spoofed fingerprint. The liveness features in the anti-spoofing templates may also include input from other sensors (e.g., body temperature, a facial recognition device, keypad input). These liveness features and sensor information may be included in the anti-spoofing templates.

At stage 1112, the method includes determining anti-spoofing features based on the overlap portion within the inquiry signal and the at least one enrollment template. The APPS processor cluster 14 may be a means for determining anti-spoofing features. In an example, the anti-spoofing features may include alignment information and features extracted from the overlap portion as applied to both the inquiry signal and a corresponding matched enrollment template. The anti-spoofing features may also be referred to as liveness features. For example, the anti-spoofing or liveness features may include ridge-valley contrast, ridge-valley thickness ratio, and ridge continuity information in the inquiry and enrollment image information. In an example, the APPS processor cluster 14 may be configured as the anti-spoofing engine 408 in FIG. 4, and may include a matcher. The APPS processor cluster 14 may be configured to compare distortions in the inquiry signal information and the enrollment signal information within the overlap portion. The signal information may be stretched, squeezed and sheared to determine global and local distortions. The spatial data in the inquiry and enrollment image information may be transformed to the frequency domain to generate distortion maps. A comparison of the distortion maps, such as in FIG. 5, may be used to determine anti-spoofing features.

At stage 1114, the method includes outputting a liveness score based on the anti-spoofing features and the at least one anti-spoofing template. The APPS processor cluster 14 may be a means for outputting the liveness score. In an example, each of the anti-spoofing templates may be associated with the user (e.g., via a userID field) to enable a personalized liveness detection. In operation, the APPS processor cluster 14 may be configured to operate as an anti-spoofing matcher capable of iterating through the different templates associated with the user (e.g., x1, x2, . . . , xn, y1, y2, . . . , yn). The liveness scores generated by the APPS processor cluster 14 may be personalized because the scores are based on user specific anti-spoofing templates, which may include various user/finger and sensor characteristics for individual users. The liveness score may be based on a correlation of anti-spoofing features in the overlap portion and an anti-spoofing template that is associated with the user. The liveness score may be output to a fusion module in an authentication system to combine with a matcher score. In an example, the liveness score and anti-spoofing features may be output to a machine learning algorithm to generate adaptive liveness models.

In an example, a liveness score may be based on comparing fine fingerprint features in the overlapping areas of the enrollment and inquiry signals (e.g., the common area 406). In a fingerprint example, these fine fingerprint features may be obtained by a smart subtraction of a raw image and the corresponding reconstructed image. Example methods for fingerprint image reconstruction may include minutiae-based methods, frequency modulation models, or other reconstruction methods known in the art. After obtaining a reconstructed image from the raw image, the smart subtraction may be performed according to the following:

Let A=a raw fingerprint image, either enrollment or inquiry image;

Let B=the reconstructed corresponding (i.e. enrollment or inquiry) image;

Step 1: divide the images into smaller blocks;

Step 2: in each block, make the mean equal zero:

Ai->Ai−mean(A), Bi->Bi−mean(B);

Step 3: in each block, subtract the image B from a according to the formula:

Ai′=Ai−βBi, where β=(ΣAiBi)/(ΣBi²).

The liveness score can be computed based on any similarity measure, for example, a distance or correlation.

Other examples and implementations are within the scope and spirit of the disclosure and appended claims. For example, while fingerprints are used in the examples above, other biometric modalities may be used. Due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal transmission between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

“About” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

1. A method of determining a liveness of a biometric input, comprising:
obtaining inquiry image information;
obtaining enrollment image information;
determining alignment information based on the inquiry image information and the enrollment image information;
determining an overlap area based on the alignment information;
determining anti-spoofing features based on the overlap area within the inquiry image information and the enrollment image information; and
outputting a liveness score based on the anti-spoofing features.

2. The method of claim 1 wherein the inquiry image information and the enrollment image information are time-based signals.

3. The method of claim 1 wherein obtaining the inquiry image information includes obtaining feature vectors derived from an inquiry image.

4. The method of claim 1 wherein obtaining the enrollment image information includes obtaining a user identification and retrieving an enrollment template from an enrollment database based on the user identification.

5. The method of claim 1 further comprising determining a matching score based on the inquiry image information and the enrollment image information.

6. The method of claim 5 wherein the anti-spoofing features are obtained from features in the overlap area of both the inquiry image information and the enrollment image information, wherein the overlap area is determined by a matching algorithm.

7. The method of claim 5 wherein the biometric input is a fingerprint and the matching score is based on key points and descriptors in the inquiry image information and the enrollment image information.

8. The method of claim 1 wherein the anti-spoofing features include the alignment information.

9. The method of claim 1 wherein the biometric input is a fingerprint and the anti-spoofing features include at least one of a ridge-valley contrast, a ridge-valley thickness ratio, or a ridge-continuity information within the overlap area within the inquiry image information and the enrollment image information.

10. The method of claim 1 wherein the biometric input is a fingerprint and the anti-spoofing features include at least one of a noise pattern, a noise characteristic, or a deformation result.

11. The method of claim 1 wherein determining the anti-spoofing features include transforming the overlap area within the inquiry image information and the enrollment image information to a frequency domain to determine a matching score.

12. The method of claim 11 wherein transforming the overlap area within the inquiry image information and the enrollment image information to the frequency domain includes determining at least one of a fingerprint frequency, a noise frequency, a frequency shift, or a rotation or scaling transformation at different frequencies.

13. The method of claim 1 wherein outputting the liveness score includes outputting a matching score based on global and local deformation results.

14. The method of claim 1 wherein outputting the liveness score includes outputting a matching score based on comparing fine fingerprint features in the overlap area of the inquiry image information and the enrollment image information.

15. The method of claim 14 wherein the fine fingerprint features are obtained by a smart subtraction of a raw image and a corresponding reconstructed image.

16. The method of claim 1 wherein outputting the liveness score includes executing local binary pattern (LBP) operations with anti-spoofing features located in the overlap area of the inquiry image information and the enrollment image information.

17. The method of claim 1 further comprising saving the anti-spoofing features as a liveness template.

18. The method of claim 17 wherein outputting the liveness score is based at least in part on a comparison of the anti-spoofing features and a previously stored liveness template.

19. A method for determining a liveness score for a biometric input, comprising:
obtaining an inquiry signal associated with a user;
obtaining at least one enrollment template associated with the user;
determining alignment information based on the inquiry signal and the at least one enrollment template;
obtaining at least one anti-spoofing template associated with the user;
determining anti-spoofing features based on the inquiry signal and the at least one enrollment template; and
outputting the liveness score based on the anti-spoofing features and the at least one anti-spoofing template.

20. The method of claim 19 further comprising:
determining an overlap portion based on the alignment information; and
determining the anti-spoofing features based on the overlap portion within the inquiry signal and the at least one enrollment template.

21. The method of claim 20 wherein the overlap portion is an overlap area extending in two dimensions.

22. The method of claim 20 wherein the liveness score is based on comparing fine fingerprint features in the overlap portion of the inquiry signal and the at least one enrollment template.

23. The method of claim 22 wherein the fine fingerprint features are obtained by a smart subtraction of a raw image and a corresponding reconstructed image.

24. The method of claim 19 wherein determining the alignment information includes determining a matching score based on keypoints and descriptors in the inquiry signal and the at least one enrollment template.

25. The method of claim 19 wherein obtaining the at least one anti-spoofing template associated with the user includes obtaining an anti-spoofing template that is associated with the at least one enrollment template.

26. The method of claim 19 wherein the at least one anti-spoofing template includes liveness features extracted from a prior enrollment signal.

27. The method of claim 19 wherein the at least one anti-spoofing template includes liveness features extracted from a prior inquiry signal.

28. The method of claim 19 wherein the at least one anti-spoofing template includes information associated with at least one of a body temperature sensor, a temperature gradient, a fingerprint depth map, or an amplitude scan.

29. An apparatus for determining a liveness of a biometric input, comprising:
means for obtaining inquiry image information;
means for obtaining enrollment image information;
means for determining alignment information based on the inquiry image information and the enrollment image information;
means for determining an overlap area based on the alignment information;
means for determining anti-spoofing features based on the overlap area within the inquiry image information and the enrollment image information; and
means for outputting a liveness score based on the anti-spoofing features.

30. An apparatus for determining a liveness score for a biometric input, comprising:
a biometric sensor;
a memory;
at least one processor operably coupled to the biometric sensor and the memory, configured to:
obtain an inquiry signal associated with a user from the biometric sensor;
obtain at least one enrollment template associated with the user;
determine alignment information based on the inquiry signal and the at least one enrollment template;
obtain at least one anti-spoofing template associated with the user;
determine anti-spoofing features based on the inquiry signal and the at least one enrollment template; and
output the liveness score based on the anti-spoofing features and the at least one anti-spoofing template.
